(19) United States
(12) Patent Application Publication
(10) Pub. No.: US 2003/0214747 A1
(43) Pub. Date: Nov. 20, 2003

(54) Servo writing method for hard disk drives

(76) Inventor: Debasis Baral, San Jose, CA (US)

Correspondence Address: IRELL & MANELLA LLP, 840 NEWPORT CENTER DRIVE, SUITE 400, NEWPORT BEACH, CA, 92660, US

(21) Appl. No.: 10/146,213

(22) Filed: May 14, 2002

(51) Int. Cl. G11B 21/02

(52) U.S. Cl. 360/75

(57) ABSTRACT

A method for writing servo information in a hard disk drive. The method includes initially writing a seed servo pattern with a servo writer and then self writing the rest of the servo patterns with the heads of the drive. Each head should preferably have a write element that is sufficiently offset from a read element toward an inner diameter of the disks. This will insure that the heads will not write over an existing servo pattern.

### 1. BACKGROUND OF THE INVENTION

1. Field of the Invention

The subject matter disclosed generally relates to the field of hard disk drives.

2. Background Information

Hard disk drives contain a plurality of magnetic heads that are coupled to rotating disks. The heads write and read information by magnetizing and sensing the magnetic fields of the disk surfaces. There have been developed magnetic heads that have a write element that magnetizes the disks and a separate read element for sensing the magnetic fields from the disks. The read element is typically constructed from a magneto-resistive material. The magnetoresistive material has a resistance that varies with the magnetic fields of the disk. Heads with magneto-resistive read elements are commonly referred to as magneto-resistive (MR) heads.

Each head is attached to a flexure beam to create an subassembly commonly referred to as a head gimbal assembly (“HGA”). The HGA's are attached to an actuator arm that has a voice coil coupled to a magnet assembly. The voice coil and magnet assembly create a voice coil motor that can pivot the actuator arm and move the heads across the disks.

Information is typically stored within annular tracks that extend across each surface of a disk. The voice coil motor can move the heads to different track locations to access data stored onto the disk surfaces. Each track is typically divided into a plurality of adjacent sectors. Each sector may have one or more data fields. Each data field has a series of magnetic transitions that are decoded into binary data. The spacing between transitions define the bit density of the disk drive. It is generally desirable to provide a high areal density to increase the overall storage capacity of the drive.

Disk drives operate servo routines to center the heads on the centerlines of the tracks. The servo routines include the steps of reading servo bits from the disks, computing a position of the heads relative to the track centerlines, and then moving the heads if there is any error in the head position.

The servo bits are written onto the disk with a servo writer during the manufacturing process of the drive. Writing servo with a servo writer requires open access to the disks. Open access allows unwanted contaminants into the disk drive. The contaminants may deposit onto the disks and degrade the operation of the drive. To minimize contamination, the servo writers are typically located in a “clean room”. Clean rooms are expensive to construct and maintain. Additionally, the servo writers are relatively expensive and occupy valuable clean room space. It would be desirable to provide a method for writing servo that would reduce the number of writers required to mass produce hard disk drives. The time required to write servo tracks increases with track densities. It is desirable to reduce total servo writing time to increase the throughput of servo track writers and the production rate of mass producing hard disk drives.

### BRIEF SUMMARY OF THE INVENTION

A method for writing servo information in a hard disk drive. The method includes writing a seed servo pattern with a servo writer and then writing a plurality of servo patterns with the heads of the disk drive.

### BRIEF DESCRIPTION OF THE DRAWINGS

FIGS. 1 is a top view of a hard disk drive;

FIG. 2 is an illustration of a track sector of a disk;

FIG. 3 is a flowchart showing a method for writing servo information in the disk drive.

### DETAILED DESCRIPTION

Disclosed is a method for writing servo information in a hard disk drive. The method includes initially writing a seed servo pattern with a servo writer and then self writing the rest of the servo patterns with the heads of the drive. Each head should preferably have a write element that is offset from a read element toward an inner diameter of the disks. This will insure that the heads will not write over an existing servo pattern as the heads move toward the center of the disks.

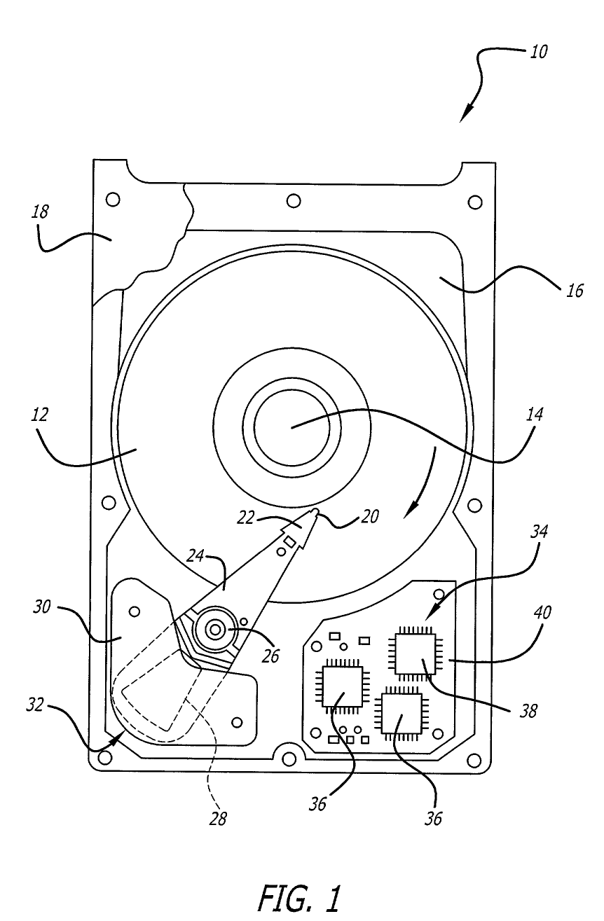

Referring to the drawings more particularly by reference numbers, FIG. 1 shows an embodiment of a hard disk drive 10. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. The heads 20 may have separate write and read elements (not shown in FIG. 1) that magnetize and sense the magnetic fields of the disks 12, respectively.

Each head 20 may be gimbal mounted to a flexure beam 22 as part of a head gimbal assembly (HGA). The flexure beams 22 are attached to an actuator arm 24 that is pivotally mounted to the base plate 16 by a bearing assembly 26. A voice coil 28 is attached to the actuator arm 24. The voice coil 28 is coupled to a magnet assembly 30 to create a voice coil motor (VCM) 32. Providing a current to the voice coil 28 will create a torque that swings the actuator arm 24 and moves the heads 20 across the disks 12.

Each head 20 has an air bearing surface (not shown) that cooperates with an air flow created by the rotating disks 12 to generate an air bearing. The air bearing separates the head 20 from the disk surface to minimize contact and wear.

The hard disk drive 10 may include a printed circuit board assembly 34 that includes a plurality of integrated circuits 36 and 38 coupled to a printed circuit board 40. The printed circuit board 40 is coupled to the voice coil 28, heads 20 and spindle motor 14 by wires (not shown).

Integrated circuit 38 may be an electronic controller that can perform software/firmware routines. The software/firmware routines may include a servo subroutine to maintain the head 20 on the center of a disk track.

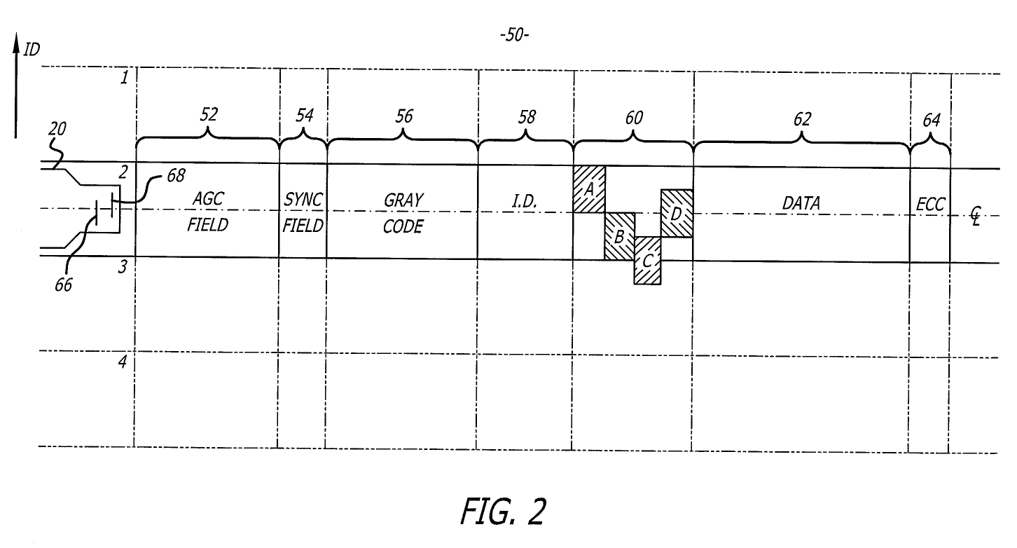

FIG. 2 shows a head 20 located on typical data sector 50 of a disk. The data stored on the disks is organized into concentric tracks that extend across the surface of the disks 10. Each track is divided up into a plurality of data sectors 50. Each sector 50 may include an AGC field 52, a sync pulse or field 54, a gray code field 56, an ID field 58, A,B,C and D servo bits 60, a data field 62 and an ECC field 64 as is known in the art.

The head 20 has a read element 66 and a write element 68. Each head 20 of the disk drive should have the write element 68 offset from the read element 66 toward the inner diameter ID of the disks 12. This insures that the heads 20 will never write over an existing servo pattern.

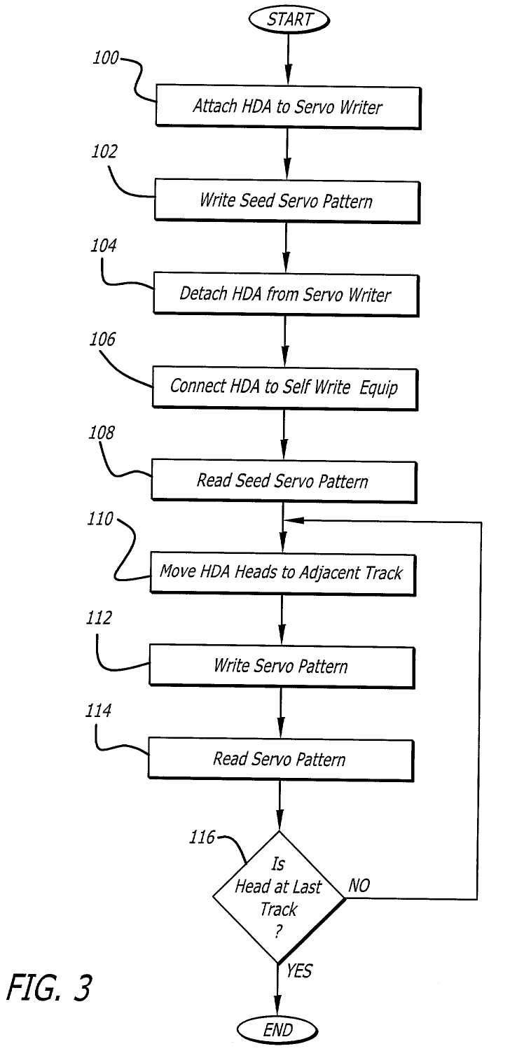

FIG. 3 is a flowchart for writing servo information on the disk 12 of the drive 10. The disk drive 10 is initially coupled to a servo writer in block 100. A seed servo pattern is then written onto each disk surface of the drive (or on just one disk if the drive has a dedicated servo system) in block 102. The seed servo pattern is preferably written onto a track located at the outer diameter of the disk 12. The servo band should be wider than the offset between the read and write elements. The servo pattern includes groups of servo bits if the disk is organized into a plurality of track sectors. The servo writer is typically located in a clean room. The pattern should have sufficient information for close loop servo operation.

After the seed servo pattern is written, the disk drive is detached from the servo writer and removed from the clean room in block 104. In block 106 the disk drive is connected to equipment that will issue commands to the drive to self write the remaining servo patterns. The self writing routine begins by having the heads read the seed servo patterns in block 108. The heads are then moved a predetermined increment away from the seed servo pattern to form an adjacent track in block 110. The heads then write a servo pattern at the new track location in block 112. In block 114 the heads read the newly written servo pattern. It is then determined whether the heads are at the last track in decision block 116. The process of moving the head, writing servo information and reading servo is repeated across the surfaces of the disk 12 until all of the desired servo information is written for the disk drive 10. For a disk drive with multiple heads one head may read a reference track while the other heads write servo patterns.

Self writing the servo without a servo writer minimizes the amount of time that each disk drive must be attached to the writer. This reduces the number of servo writers required to mass produce hard disk drives. Reducing the number of servo writers decreases the capital expenses needed to produce the drives, including the cost of the writers and the corresponding clean room space.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method for writing servo information in a hard disk drive, comprising:
writing a seed servo pattern on a track of a disk with a servo writer;
reading the seed servo pattern with a head of the hard disk drive;
moving the head to an adjacent track; and,
writing a servo pattern on the adjacent track with the head of the hard disk drive.

2. The method of claim 1, wherein the head has a read element and a write element, the write element being offset from the read element toward an inner diameter of the disk.

3. The method of claim 1, wherein the servo pattern includes a plurality of servo bits located in a plurality of track sectors.

4. The method of claim 3, wherein the seed servo pattern is written at an outer diameter of the disk.

5. A hard disk drive, comprising:
a base plate;
a spindle motor coupled to said base plate;
a disk coupled to said spindle motor, said disk having an inner diameter;
an actuator arm mounted to said base plate;
a voice coil motor coupled to said actuator arm;
a plurality of flexure beams coupled to said actuator arm;
a plurality of heads coupled to said flexure beams and said disk, each head having a read element and a write element, each write element being offset from said read element toward the inner diameter of the disk; and,
a controller coupled to said heads and said voice coil motor.

6. The assembly of claim 5, wherein said controller causes said head to read a seed servo pattern on a track and then write a servo pattern on an adjacent track.

7. The assembly of claim 6, wherein said seed servo pattern is located on an outer diameter of said disk.

8. The assembly of claim 6, wherein the servo pattern includes a plurality of servo bits located in a plurality of track sectors.

9. A hard disk drive, comprising:
a base plate;
a spindle motor coupled to said base plate;
a disk coupled to said spindle motor, said disk having a seed servo pattern and a plurality of servo patterns;
an actuator arm mounted to said base plate;
a voice coil motor coupled to said actuator arm;
a flexure beam coupled to said actuator arm;
a head coupled to said flexure beam and said disk; and
a controller coupled to said head and said voice coil motor.

10. The hard disk drive of claim 9, wherein said seed servo pattern is located at an outer diameter of said disk.

11. The hard disk drive of claim 10, wherein said controller causes said head to read said seed servo pattern on a track and then write a servo pattern on an adjacent track.
